(19) United States
(12) Patent Application Publication
(10) Pub. No.: US 2002/0176607 A1
(43) Pub. Date: Nov. 28, 2002

(54) Security door

(76) Inventors: Derek Bond, West Sussex (GB); Mark Geering, East Sussex (GB)

Correspondence Address: BROMBERG & SUNSTEIN LLP, 125 SUMMER STREET, BOSTON, MA, 02110-1618, US

(21) Appl. No.: 10/152,154

(22) Filed: May 21, 2002

(30) Foreign Application Priority Data
May 21, 2001 (GB) 0112334.8
May 21, 2001 (GB) 0112335.5
May 13, 2002 (GB) 0210900.7

(51) Int. Cl. G06K 9/00

(52) U.S. Cl. 382/107

(57) ABSTRACT

A system for monitoring the passage of people through a controlled location, the system comprising; a security access device for selectively allowing and preventing the passage of one or more people through the controlled location; a thermal imaging device for obtaining movement and temperature information relating to people passing through the controlled location; and processing means for analysing the detective movement and temperature information for use in controlling the operation of the security access device.

The present application claims priority from three British patent appliations, GB 0112334.8 and GB 0112335.5, filed May 21, 2001, and GB 0210900.7, filed May 13, 2002, all of which applications are incorporated herein by reference.

### FIELD OF THE INVENTION

This invention relates to a control system for use with a security door, with interlocking or synchronised doors, or with other means, such as turnstiles, flaps or other obstacles, for controlling access to a secured area.

### BACKGROUND OF THE INVENTION

A typical security door may comprise a revolving door divided into, for example, four compartments by radially extending wings. The wings are coupled centrally at their upper or lower end to an interlock operated by a control system and are typically motor driven, but may alternatively be pushed manually. Turnstile systems are generally free to be pushed manually.

The control system may operate, for example, in response to a card reader. An authorised person wishing to pass through the door will then insert their pass card into the reader and, provided that their card is recognised, the control system then operates the interlock to free the revolving door so the user can pass through. If the card is not recognised, or if an unauthorised person attempts to gain access without use of the pass card reader, then the interlock holds the wings of the revolving door against movement and so prevents passage through the door.

Known security doors suffer from a number of potential forms of misuse. In particular, they are vulnerable to “piggy backing” in which two or more individuals attempt to pass through the door in one compartment with only one authorised passage and to “tail gating” in which an unauthorised person enters the compartment immediately following the one containing the authorised person or passes through the door in the opposite direction. Previously suggested means such as pressure sensitive door mats in the security door, or the use of ultrasonic sensors to detect the presence of more than one person in the door, have not been wholly successful in preventing the above problems.

Accordingly, the present invention aims to provide a system by which the above mentioned problems can be prevented, or, at the very least, significantly reduced.

### SUMMARY OF THE INVENTION

According to the present invention there is provided a system for monitoring the passage of people through a controlled location, the system comprising:

a security access device for selectively allowing and preventing the passage of one or more people through the controlled location;

a thermal imaging device for obtaining movement and temperature information relating to people passing through the controlled location; and

processing means for analysing the detected movement and temperature information for use in controlling the operation of the security access device.

Preferably, the thermal imaging device is provided in the ceiling of the security access device and is downwardly pointing, and is provided with a detector array by which the temperature of a human body is detected such that the size and direction of movement of the body can be tracked through the door. Preferably, the processing means derives parameters from the detected movement and temperature information such that the number of persons in the controlled location can be counted. This count and the image detail can then be further processed to control the operation of the security access device.

The thermal imaging device can easily discriminate between one of two people and thus can provide a signal by which the security access device can selectively prevent passage through the controlled location.

As human beings always radiate at the same, or at least very similar, body temperature, whereas the background temperature varies according to the ambient environment, it is simple to determine the number of people within the controlled location. Furthermore, since the image is “black body radiation” and not reflected radiation, it is very difficult for an intruder to remain undetected, for example, by using a cloak of the same colour as the floor of the security access device. Furthermore, should two people stand together, they can be easily be discriminated, in the software, by their electrical image centres.

Preferably, the system is provided with sensor and detection electronics which will only track slowly moving thermal images such that both stationary and fast moving images are filtered out. In this way, the discrimination of a person walking normally against his background will be substantially enhanced.

Preferably, the active image detection regions may be varied within the control software to allow for differently sized doors and to discriminate against people leaning on the outside of the door and who would not be moving under any sensors.

If the ambient background temperature is, by chance, exactly the same as a human body, there is a possibility that the thermal sensor will not detect the person. Accordingly, the system may be fitted with a very low level heated or cooled floor mat to ensure contrast detection by the sensor as the person walks over it.

The detection and discrimination electronics may be built into the thermal imaging device to ensure a fast response time and subsequently reduce the need for subsequent image processing. The imaging device then triggers, from reference lines on an image array processor, in such a way that, as two people are counted when they enter the door, this can be verified before they leave the door so that their passage can be prevented.

The sensor may also detect the direction of motion of the persons in the controlled location and this can be used to prevent tailgating without the need for extensive image processing delays.

### BRIEF DESCRIPTION OF THE DRAWINGS

Examples of the present invention will now be described in detail with reference to the accompanying drawings, in which:

FIG. 1 is a schematic plan view of a system according to the present invention; and, FIG. 2 is a schematic plan view of a thermal sensor array;

FIG. 3 is a more detailed view of the sensor array of FIG. 2;

FIG. 4 shows a simplified schematic view of an example of a sensor processor; and

FIGS. 5 to 8 show typical wave forms from a sensor array under a number of different conditions of use.

### DETAILED DESCRIPTION

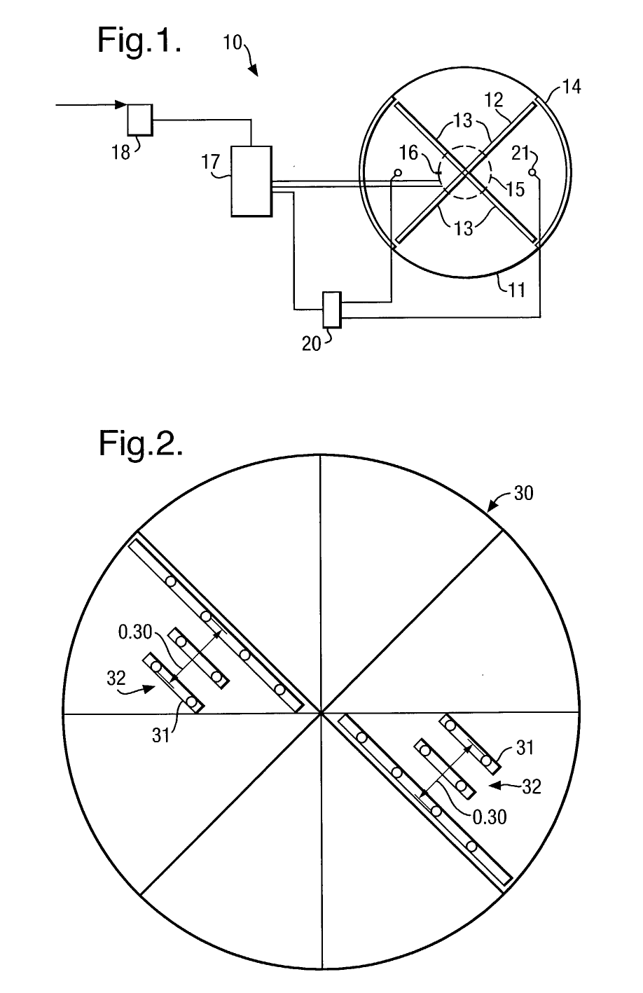

In FIG. 1, the security control system 10 is provided with a security door 11 which comprises a revolving door member 12 having four wing members 13 equally spaced at 90° intervals, defining four quadrants. Whilst four wing members are preferable, it is envisaged that any suitable number may be used, in particular three. The security door 11 also comprises two outer body parts 14 on opposite sides of the security door, each outer body part 14 extending over an arc which is at least the same as that between adjacent wing members 13. A drive unit 15 is provided to initiate and drive the movement of the revolving door member and is typically provided with a motor (not shown). Processing means 17 for controlling the system 10 is powered by a power supply 18 which may be AC or DC supply. The processing means 17 is connected to a user interface 18 by which relevant control parameters may be set. The processing means is also connected to drive motion sensors 16 and to a thermal image device interface 20. Connected to the thermal imaging device interface 20 are a number of thermal imaging devices 21 which are located such that they can detect the passage of people through the security door 11.

FIG. 2 shows a typical sensor layout for a 2-meter revolving door 30. The security door ceiling contains a distributed array 31 of downward pointing thermal (PIR) sensors 32 mounted in the ceiling. The sensors may be Pyroelectric Human Movement Detectors of the type NiCERA SDA02 made by Nippon Ceramic Co. These detect the infra-red radiation from a human body walking underneath, in such a way that the size of the person and their direction of movement can be tracked through the doorway. The sensors 32 are each positioned in the ceiling looking downwards with a detection beam angle of typically 10 to 20 degrees so that it is impossible for a person to avoid passing sequentially underneath several sensors at the same time. The detection beam angle may be varied by a beam angle controller. Typically four or five out of the array of eight shown are passed. For different door shapes, other sensor patterns may be used, but, in any arrangement, the essential principal is that the whole region from ceiling to floor is covered by a distributed array 31 in such a way that multiple concurrent views of any occupant can be taken.

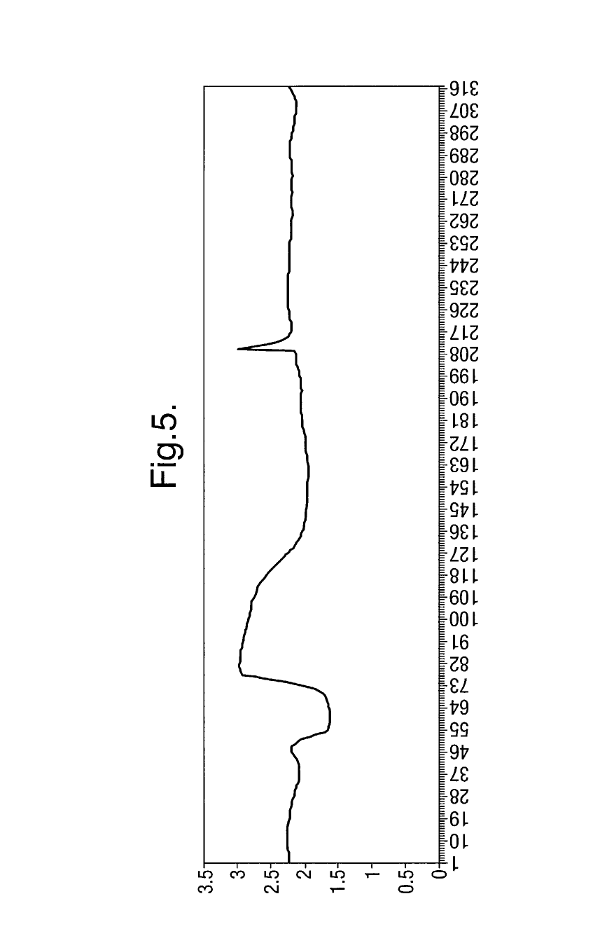

The detection method constructs line scans from under each sensor 32, the line sensors being synchronised with the door rotation. As the person passes through the array and the sensors detect the person, the sensor outputs are first amplified and filtered, then scanned at typically several hundred times per second by a microcontroller based image processor. A software state machine is used to compare the signals from each sensor with that of its neighbours, and from the rise times, relative phase and amplitudes of the signals, an image profile of the person is built up as they move through the doorway. A single person will only generate one profile in time and space, and as two people cannot occupy the same space at the same time, this provides a different trace on the resulting waveforms, as can be seen by FIGS. 5 to 8. With typical sensor spacing of 200 mm, a spatial resolution of 50 mm is possible. A typical person measures 300 mm by 450 mm and is thus resolved as one, whereas two people typically will occupy at least 500 by 600 mm and may thus be discriminated from a single person. The inevitable small gaps that exist between the shape of two persons provide confirmation that it is not one large person passing through the door as it is not possible for one person to move in two directions at once and two persons, even close together, must take different routes though the doorway, and therefore are detected.

Human beings always radiate at the same body temperature, whereas the background temperature will vary according to the ambient environment. Furthermore, since the image, i.e. the person, is black body radiation, not reflected radiation, it is very difficult for an intruder to remain undetected by, for example, using a cloak of the same colour as the floor. The thermal radiation transmits through the person's clothing. Thus the sensor array distinguishes between an actual person and his/her surroundings.

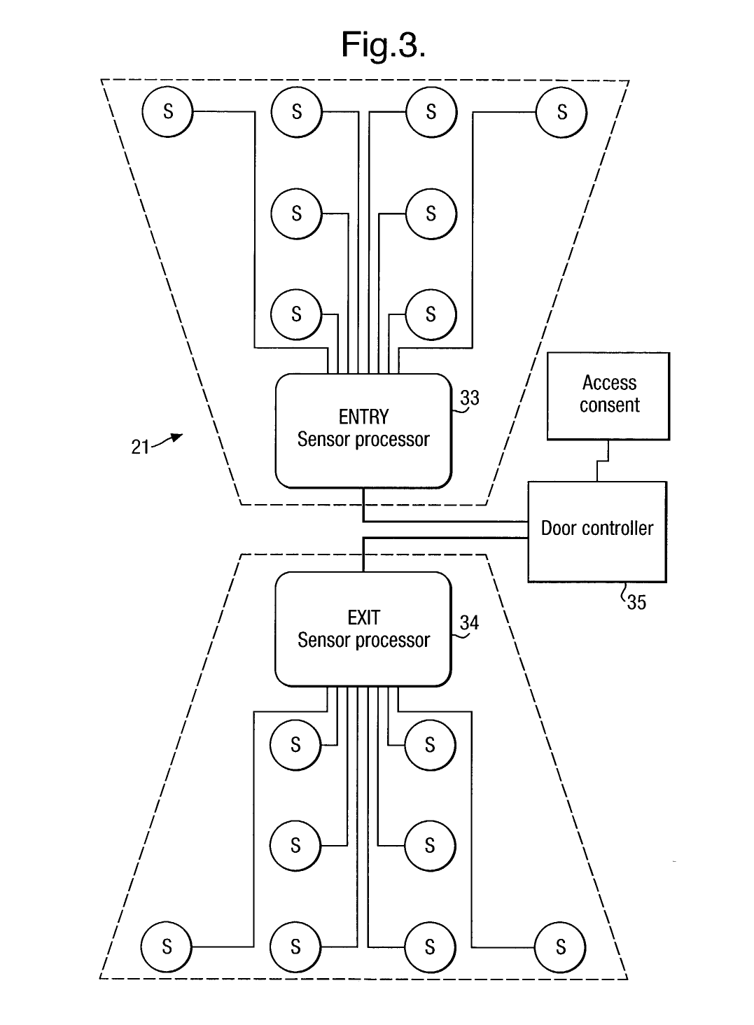

FIG. 3 shows the sensor array 31 of FIG. 2 in more detail. The sensors 32 are marked S in FIG. 3 and are mounted into the ceiling panel through which a hole is cut to give a narrow viewing angle down to the floor below. The sensors themselves are powered from a sensor processor 33, 34, and send out a signal to a door controller 35 when any radiation level changes are perceived within their field of view. The door controller is controlled in turn by an access consent device which determines whether or not the door is allowed to rotate. They are mounted in an array to give full coverage of the area under observation. In this example, the array comprises three rows of sensors, four in a first row nearest a wing member 13 and second and third rows of two sensors, each of the second and third rows being aligned with the central pair of sensors in the first row. Typically, the first and third rows are spaced apart by 300 mm for a 2 m door. The figure shows two arrays, one to cover the entrance area, and another to cover the exit. If entry and exit are through the same area then the system may need only one array.

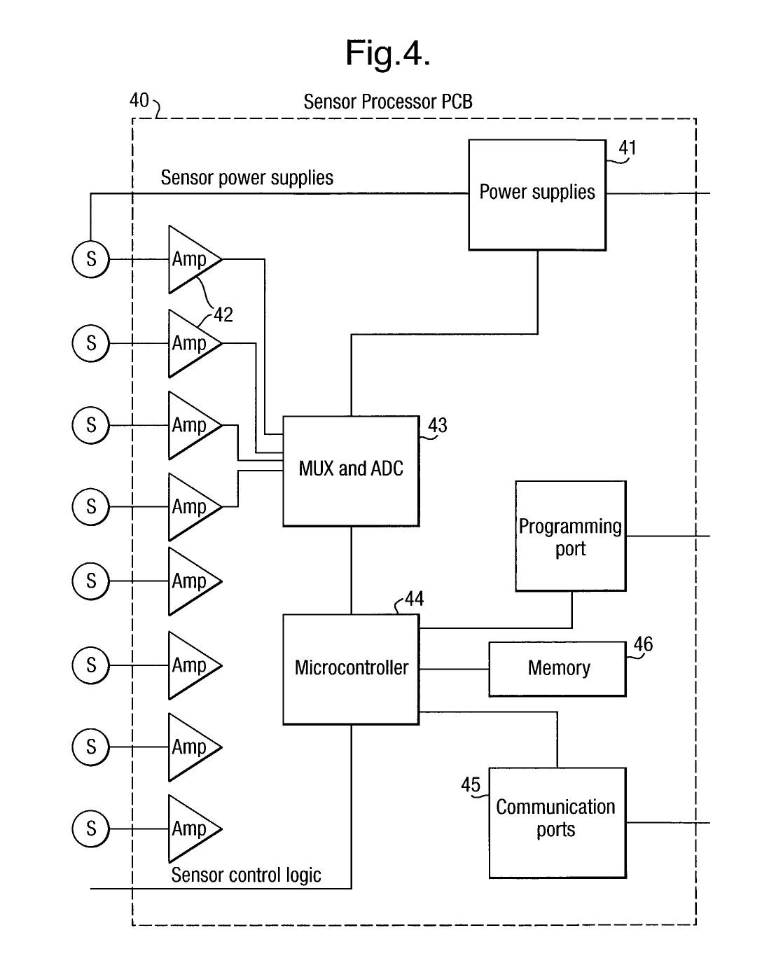

As shown in FIG. 4, each sensor processor is a printed circuit board 40 that includes power supplies 41 for the sensors, signal conditioning and filtering functions 42, an analogue to digital converter 43, a microcontroller 44, communications hardware 45, a memory 46 and a programming port 47. Its principal functions are as follows:

1. Sensor amplifier/filter

The small signals from the sensors are further amplified and filtered. The DC off-set and high frequency signal components are removed to give a clean signal with a bandwidth covering the typical sensor response. A digital control signal is sent out to the sensors to turn them on and off for calibration.

2. ADC

The sensor outputs are scanned simultaneously and digitised at high speed upon command from the microcontroller, to give a 12-bit digital data stream corresponding to the instantaneous amplitude of each channel. This data is then passed immediately for processing.

3. Communications ports

A door controller sends wing position and start signals to the sensor processor via communications ports which may be parallel or serial. Person detect signals are sent back to the door controller via these ports, so the door may be stopped, thus preventing access.

4. DSP Microcontroller

The DSP microcontroller is pre-programmed to analyze the incoming sensor data streams in real time and process them via a customized software state machine to give a very condensed history of each sensor output, and thus build up a virtual image of the scene covered by the sensors. The state history is accumulated as the person passes through the door compared to allowed /disallowed conditions. The first signal to be sent to the door controller is a person detect. If the states then stay within allowed conditions for one person, then a pass signal is sent at a pre determined point in time or door position. If another person enters the door, the sensor states will change to create a disallowed condition, and a fail or reject signal is sent to the door controller, in time to stop access.

5. Programming ports

Setting up and changing of parameters in software may be required to cope with differing levels of security. The programming port allows these to be changed with the system in situ, by means of a portable personal computer, or a network. Also the status of the door may be read from the network. Each person who is allowed to pass through the door is given the option of entering the first or second quadrant following an acceptance command. The system can detect and reject two persons who try to enter the first door quadrant (piggybacking), or someone who quickly moves into the next adjacent quadrant (tailgating). The detection system therefore continuously monitors the status of all sensors at high speed, (typically several hundred times per second), so that the rejection can occur within a very short time, typically one second, from the second person entering. The process to do this is implemented in software in a much more efficient manner than normal data acquisition or video imaging methods. Traditional digital signal processing methods require the storing of an image from the sensors in memory arrays and subsequent image analysis to recognize objects. The present invention takes advantage of the fact that any person who enters the door is constrained by the sides of the door frames, and must move through at the speed of the door. The sensors are placed so that the typical person must be covered by four or five sensors as they pass through.

Although different people will be different sizes, the size of any one person is unlikely to change much within the short period of traversing the doorway. Each individual sensor therefore collects a line scan of the person profile as they pass underneath, which should be replicated in time as they pass successive sensors. The integrals of these sensor data blocks within a time period should be smooth without major transitions. If another person enters the quadrant, or the adjacent quadrant, they must do so as the first person has passed over the first array of sensors, and the phase of the signals become positive when they should be going negative. The software algorithms detect this transition and stimulate a rejection signal.

Typical waveforms from real sensors on a working door are shown in FIGS. 5 to 8.

FIG. 5 shows one person passing under one sensor in a quadrant. Note the person profile, then door wing pulse, followed by empty quadrant at the end.

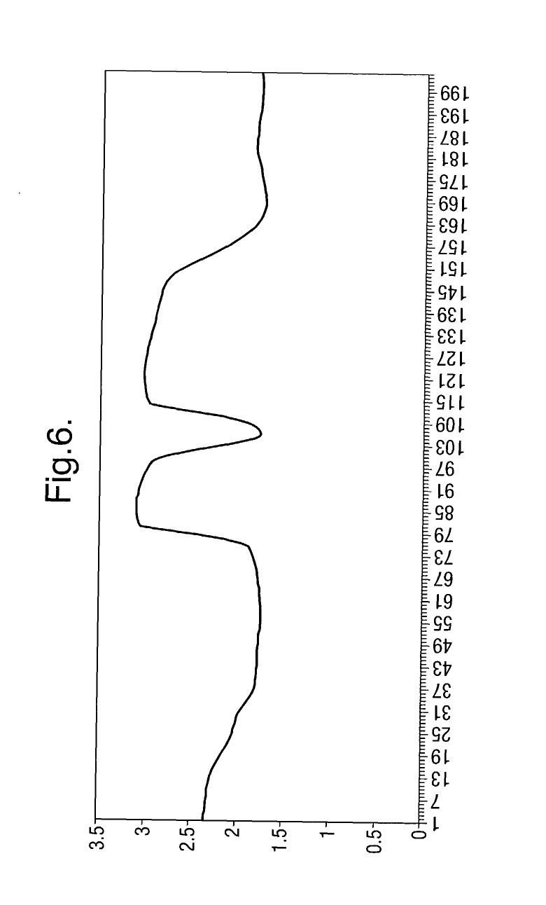

FIG. 6 shows two persons in the quadrant to the same scale.

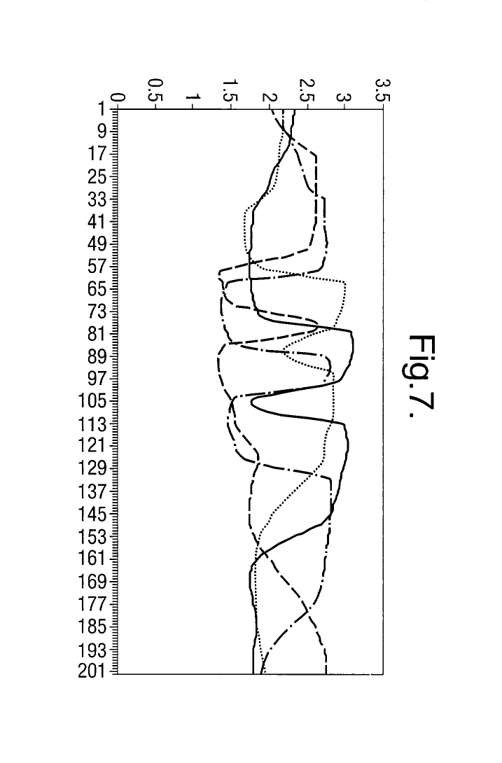

FIG. 7 shows two persons passing under multiple sensors. Note the time shift of double pulses as they pass sequentially under sensors displaced in space.

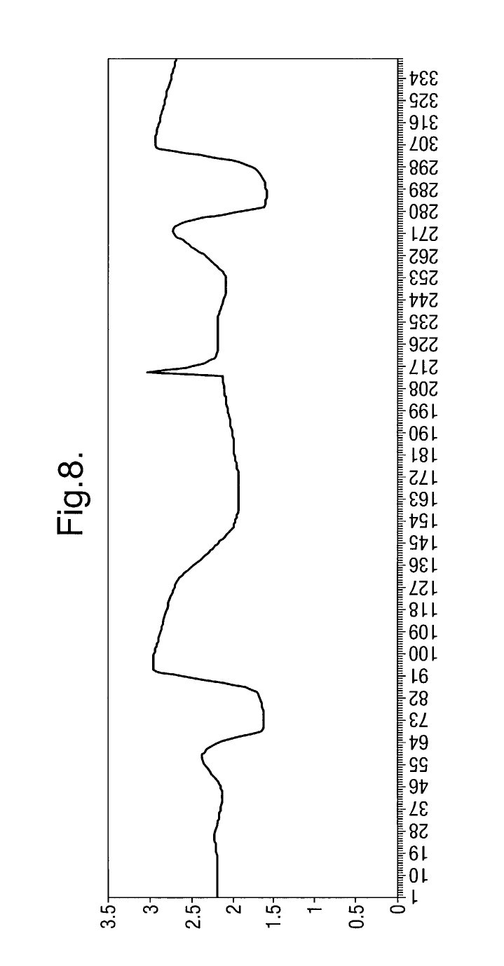

FIG. 8 shows an example of tailgating. Note that the second person moves into second quadrant after the door wing pulse.

The system works much faster, and is much more efficient and effective than a simple thermal image camera. The thermal image camera suffers from slow response, and the need to store and subsequently analyse the image array data, whereas the system described processes the image data as generated in real time. The distributed downward viewing sensor array cannot be masked in the same way that one person may hide behind another to avoid a conventional camera.

A person holding a case or wearing a rucksack will still be seen as one person by the thermal sensor, whereas ultrasonic or imaging cameras can be confused.

To prevent the system being interfered with by random environmental changes, for example, the sun coming out, the sensor and detection electronics contain filters which only track slowly moving thermal images, which move at the door rotation speed, and both stationary and fast moving images are thus filtered out. This is achieved by a combination of sensor filtering and digital signal processing in the processing software. In this way the discrimination of a person walking normally against his background may be substantially enhanced.

We claim:

1. A system for monitoring the passage of people through a controlled location, the system comprising;
a security access device for selectively allowing and preventing the passage of one or more people through the controlled location;
a thermal imaging device for obtaining movement and temperature information relating to people passing through the controlled location; and
processing means for analysing the detective movement and temperature information for use in controlling the operation of the security access device.

2. A system according to claim 1, wherein the thermal imaging device is provided in a ceiling of the security access device and is downwardly pointing.

3. A system according to claim 1, wherein the thermal imaging device comprises an array of thermal imaging sensors, each sensor characterized by a detection beam angle.

4. A system according to claim 3, wherein the array comprises three rows of sensors.

5. A system according to either of claims 3 and 4, wherein the thermal imaging device is provided in a ceiling of the security access device and is downwardly pointing.

6. A system according to either of claims 3 and 4, further comprising a beam angle controller for varying the detection beam angle of the sensors.

7. A system according to any of claims 3 and 4, wherein the detection beam angle of the sensors is between 10° and 20°.

8. A system according to any of claims 1 through 4, wherein the security access device is a winged revolving door, the door defining a plurality of segments between adjacent wings.

9. A system according to claim 8, wherein an array of sensors is provided in one or more of the segments.

10. A system according to any claims 1 through 4, wherein the processing means includes filters which filter out stationary and quickly moving images, thereby ensuring that only people moving through the security access device are detected.

11. A system according to claim 8, wherein the processing means includes filters which filter out stationary and quickly moving images, thereby ensuring that only people moving through the security access device are detected.

12. A system according to any of claims 1 through 4, further comprising a heated or a cooled floor mat to provide contrast with a person passing through the security access device.

13. A system according to claim 8, further comprising a heated or a cooled floor mat to provide contrast with a person passing through the security access device.

14. A system according to any of claim 11, further comprising a heated or a cooled floor mat to provide contrast with a person passing through the security access device.
